(19) United States
(12) Patent Application Publication
(10) Pub. No.: US 2026/0104286 A1
(43) Pub. Date: Apr. 16, 2026

(54) ACOUSTIC SENSOR

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP); Nisshinbo Micro Devices Inc., Tokyo (JP)

(72) Inventors: YUYA SAKURAI, Nisshin-shi (JP); HIDEO YAMADA, Nisshin-shi (JP); TOMOYA JOKE, Nisshin-shi (JP); TAKAHIDE USUI, Fujimino-shi (JP); KENTARO SHIRAISHI, Nisshin-shi (JP); YO KUBOTA, Fujimino-shi (JP)

(21) Appl. No.: 19/283,973

(22) Filed: Jul. 29, 2025

(30) Foreign Application Priority Data
Oct. 11, 2024 (JP) 2024-178948

(51) Int. Cl. G01H 11/08

(52) U.S. Cl. CPC G01H 11/08

(57) ABSTRACT

An acoustic sensor includes a support member and a vibration unit. A vibration unit is located on the support member. The vibration unit includes a support region and a vibrating region. The support region is supported by the support member. The vibrating region generates vibration. The vibration unit outputs a detection signal according to deformation of the vibrating region. The support member includes a recess at a section facing the vibrating region. The vibrating region includes a section that receives a compressive stress. The vibration unit has a stress relief hole.

### CROSS REFERENCE TO RELATED APPLICATION

This application is based on Japanese Patent Application No. 2024-178948 filed on Oct. 11, 2024, the disclosure of which is incorporated herein by reference.

### TECHNICAL FIELD

The present disclosure relates to an acoustic sensor.

### BACKGROUND

An acoustic sensor may be a piezoelectric sensor having a vibrating region. The piezoelectric sensor may include a vibration unit and a support member. The vibration unit may have a vibrating region and a support region, and a support member may support the support region of the vibration unit. The vibrating region may be in a state of being hanged from the support member.

### SUMMARY

According to an aspect of the present disclosure, an acoustic sensor includes a support member and a vibration unit. The vibration unit is located on the support member. The vibration unit includes a support region and a vibrating region, the support region being supported by the support member. The vibrating region generates vibration. The vibration unit outputs a detection signal according to deformation of the vibrating region. The support member may include a section having a recess, and the section is located to face the vibration region. The vibration region may include a section that receives a compressive stress. The vibration unit may have a stress relief hole.

### BRIEF DESCRIPTION OF DRAWINGS

FIG. 1 is a plan view of a piezoelectric sensor according to a first embodiment.

FIG. 2 is a cross-sectional view taken along a line II-II in FIG. 1.

FIG. 3 is a perspective view showing a single vibrating region.

FIG. 4 is a diagram showing the amount of displacement of the vibrating region.

FIG. 5A is a cross-sectional view showing a manufacturing process of the piezoelectric sensor shown in FIG. 1.

FIG. 5B is a cross-sectional view showing a subsequent manufacturing process of the piezoelectric sensor shown in FIG. 5A.

FIG. 6 is a cross-sectional view of the piezoelectric sensor according to a second embodiment.

FIG. 7 is a plan view of a piezoelectric sensor according to a third embodiment.

FIG. 8 is a cross-sectional view taken along a line VIII-VIII in FIG. 7.

FIG. 9 is a plan view of a piezoelectric sensor according to a fourth embodiment.

FIG. 10 is a cross-sectional view taken along a line X-X in FIG. 9.

FIG. 11 is a diagram showing the amount of displacement in the vibrating region.

FIG. 12A is a cross-sectional view illustrating a manufacturing process of the piezoelectric sensor shown in FIG. 10.

FIG. 12B is a cross-sectional view illustrating a subsequent manufacturing process of the piezoelectric sensor following FIG. 12A.

FIG. 12C is a cross-sectional view illustrating a subsequent manufacturing process of the piezoelectric sensor following FIG. 12B.

FIG. 12D is a cross-sectional view illustrating a subsequent manufacturing process of the piezoelectric sensor following FIG. 12C.

FIG. 12E is a cross-sectional view illustrating a subsequent manufacturing process of the piezoelectric sensor following FIG. 12D.

### DETAILED DESCRIPTION

A piezoelectric sensor may include a vibration unit having a piezoelectric film and an electrode film. The piezoelectric film and the electrode film are formed, for example, by sputtering or other deposition methods. Therefore, the vibration unit may be in a state where internal stress remains. When compressive stress as internal stress occurs in a vibrating region of the vibration unit, the acoustic sensor may experience a decrease in sensitivity because the vibrating region buckles and becomes structurally stiff. Therefore, in this piezoelectric sensor, the vibrating region may be partially thickened to make it less prone to buckling.

However, when the vibrating region is partially thickened, the thickened portion may become less prone to deformation. Therefore, although this configuration can suppress the sensitivity reduction due to buckling, the thickened portion may lead to a decrease in sensitivity, and it may not be possible to sufficiently prevent the sensitivity reduction.

According to an aspect of the present disclosure, an acoustic sensor may include a support member and a vibration unit. The vibration unit is located on the support member. The vibration unit includes a support region and a vibrating region. The vibrating region generates vibration. The vibration unit outputs a detection signal according to deformation of the vibrating region. The support member includes a recess at a section facing the vibrating region. The vibrating region includes a section having a compressive stress. The vibration unit has a stress relief hole.

According to the above-mentioned structure, a stress relief hole may be formed in the vibration unit. Therefore, the compressive stress in the vibrating region may be relieved through the stress relief holes, and buckling of the vibrating region may be prevented. Additionally, it may not be necessary to thicken the vibrating region, so the sensitivity may not decrease due to the stress relief holes. Therefore, a decrease in sensitivity may be prevented.

The embodiments of the present disclosure will be described below with reference to the figures. In the following respective embodiments, parts that are identical or equivalent to each other will be denoted by the same reference numerals and described accordingly.

### First Embodiment

An acoustic sensor according to a first embodiment will be described. In this embodiment, a piezoelectric sensor applied to a microphone or the like will be described as an example of the acoustic sensor.

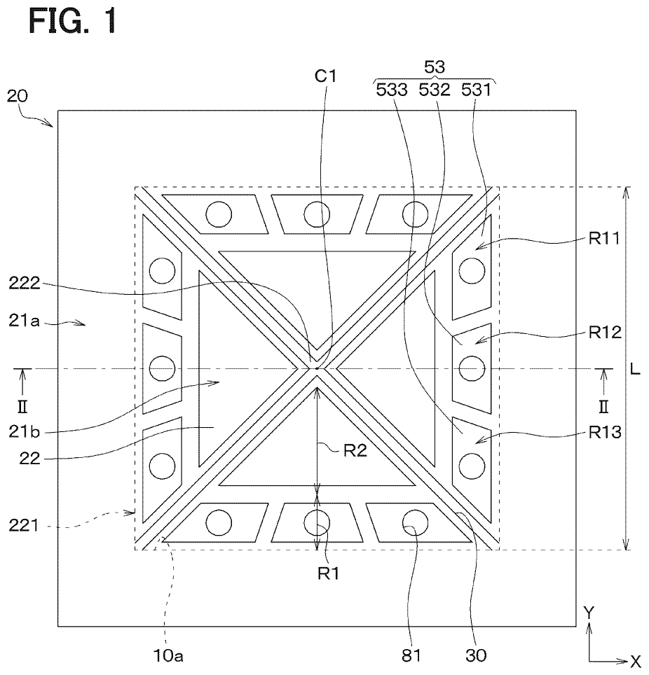

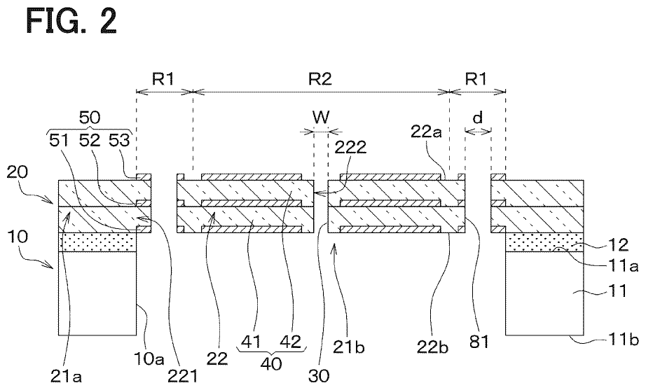

As shown in FIGS. 1 to 3, the piezoelectric sensor includes a support member 10 and a vibration unit 20, and has a rectangular planar shape. The support member 10 includes a support substrate 11 having a first surface 11a and a second surface 11b, and an insulating film 12 formed on the first surface 11a of the support substrate 11. The support substrate 11 includes, for example, a silicon substrate, and the insulating film 12 includes an oxide film or the like. Furthermore, in the following description, one direction along the plane of the vibration unit 20 is referred to as an X-axis direction, and another direction along the plane of the vibration unit 20 that is orthogonal to the X-axis direction is referred to as a Y-axis direction. In FIG. 1, the left-right direction on the paper corresponds to the X-axis direction, and the up-down direction on the paper corresponds to the Y-axis direction.

The vibration unit 20 is arranged on the support member 10. The support member 10 is formed with a recess 10a for suspending the inner edge side of the vibration unit 20. Therefore, the vibration unit 20 is configured to have a support region 21a arranged on the support member 10, and a suspending region 21b connected to the support region 21a and suspending above the recess 10a. In other words, in the stacking direction of the support member 10 and the vibration unit 20, the portion of the vibration unit 20 that overlaps with the recess 10a is designated as the suspending region 21b, while the region different from the suspending region 21b is designated as the support region 21a. In other words, the recess 10a is formed in the portion facing the suspending region 21b (i.e., a vibrating region 22, which will be described later). The suspending region 21b may also be referred to as a floating or hanging region. The term “suspending” may also be referred to as “hanging” in the present disclosure. The suspending region 21b may also be referred to as a suspended portion of the vibration unit 20.

The recess 10a in this embodiment is formed to penetrate through the support substrate 11 and the insulating film 12 to expose the vibration unit 20, with the shape of the opening end on the vibration unit 20 side being a planar rectangle. Therefore, the entire suspending region 21b is shaped as a planar rectangle. More specifically, the entire suspending region 21b is shaped as a square with equal lengths in the X-axis direction and the Y-axis direction. Additionally, the stacking direction of the support member 10 and the vibration unit 20, in other words, is the same direction as the normal direction to a first surface 22a of the vibrating region 22, which will be described later.

In the suspending region 21b according to this embodiment, a slit 30 that penetrates the suspending region 21b in the thickness direction is formed. The slit 30 in this embodiment is formed so as to divide the suspending region 21b into four segments. Specifically, two slits 30 are formed to pass through the central part C1 of the suspending region 21b and extend toward the opposing corners of the suspending region 21b. In other words, the slits 30 are formed to extend from each corner of the rectangular planar suspending region 21b toward the central part C1, with each slit 30 intersecting at the central part C1. As a result, the suspending region 21b is divided into four vibrating regions 22, each having a roughly planar triangular shape. The four vibrating regions 22 may also be referred to as four vibrating segments. In this embodiment, the slits 30 are formed to reach the recess 10a, but the slits 30 may also be configured to terminate within the suspending region 21b. In other words, each vibrating region 22 may be connected at the portion on the recess 10a side. Furthermore, although not particularly limited, in this embodiment, the spacing between each vibrating region 22 (i.e., the width W of the slits 30) is set to approximately 1 micrometer (μm).

Each vibrating region 22 has a cantilever structure, where a first end portion 221 on the support region 21a side is a fixed end, and a second end portion 222 on the opposite side of the support region 21a is a free end. Hereinafter, the surface of the vibrating region 22 opposite to the support member 10 will be referred to as a first surface 22a of the vibrating region 22, and the surface on the support member 10 side will be referred to as a second surface 22b of the vibrating region 22. Incidentally, the first end portion 221 of the vibrating region 22 in this embodiment can be said to be the portion that coincides with the opening end on the vibration unit 20 side of the recess 10a in the normal direction.

The vibration unit 20 has a bimorph structure that includes a piezoelectric film 40 and an electrode film 50 connected to the piezoelectric film 40. Specifically, the piezoelectric film 40 includes a lower piezoelectric film 41 and an upper piezoelectric film 42 stacked on the lower piezoelectric film 41. Incidentally, the lower piezoelectric film 41 and the upper piezoelectric film 42 are made of lead-free piezoelectric ceramics such as scandium aluminum nitride (ScAlN) or aluminum nitride (AlN).

The electrode film 50 is formed at a predetermined location in the vibrating region 22 so as to be connected to the piezoelectric film 40, and is made of materials such as molybdenum, copper, platinum, or titanium. In this embodiment, the electrode film 50 includes a lower electrode film 51 formed below the lower piezoelectric film 41, an intermediate electrode film 52 formed between the lower piezoelectric film 41 and the upper piezoelectric film 42, and an upper electrode film 53 formed above the upper piezoelectric film 42.

Incidentally, the lower electrode film 51 and the intermediate electrode film 52 are arranged to face each other with the lower piezoelectric film 41 sandwiched between the lower electrode film 51 and the intermediate electrode film 52. The intermediate electrode film 52 and the upper electrode film 53 are arranged to face each other with the upper piezoelectric film 42 sandwiched between the intermediate electrode film 52 and the upper electrode film 53. Furthermore, the lower electrode film 51, intermediate electrode film 52, and upper electrode film 53 have similar shapes in the normal direction with respect to the first surface 22a of the vibrating region 22 (hereinafter also simply referred to as the normal direction). Incidentally, the normal direction with respect to the first surface 22a of the vibrating region 22 can also be described as the direction viewed from the normal direction to the first surface 22a of the vibrating region 22. Additionally, the lower electrode film 51, the intermediate electrode film 52, and the upper electrode film 53 having similar shapes means that they can have completely identical shapes or include slight variations in shape.

Here, in a case where the vibrating region 22 is cantilevered as in the present embodiment, the stress generated when the vibrating region 22 (i.e., the piezoelectric film 40) vibrates tends to be greater on the fixed end side where the vibrating region 22 is supported than on the free end side. In other words, the stress generated when the vibrating region 22 (i.e., the piezoelectric film 40) vibrates tends to be greater on the first end portion 221 side than on the second end portion 222 side. Therefore, it can be said that the vibrating region 22 is configured to have a first region R1 on the first end portion 221 side where stress tends to be greater, and a second region R2 on the second end 222 side where stress tends to be smaller. In the present embodiment, the electrode films 50 are formed in both the first region R1 and the second region R2. However, in the present embodiment, the electrode film 50 formed in the first region R1 and the electrode film 50 formed in the second region R2 are in an insulated state from each other.

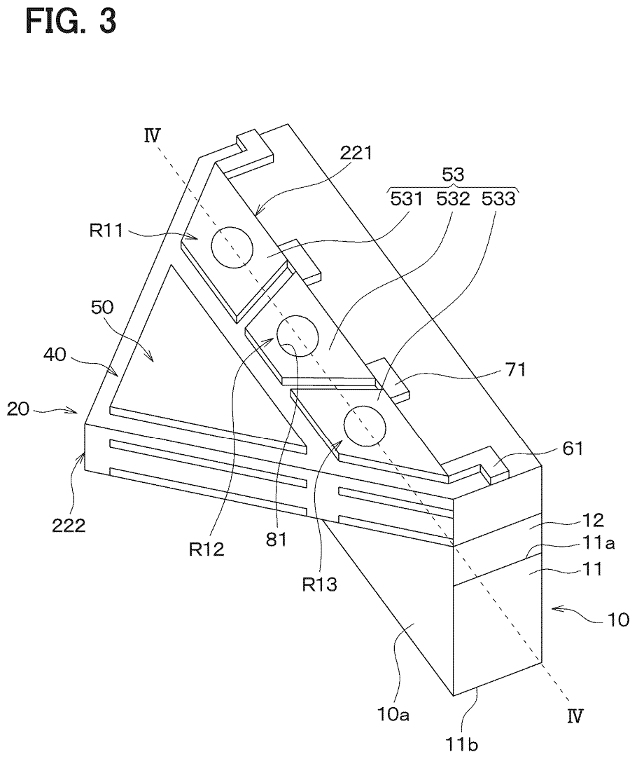

As shown in FIG. 3, the electrode film 50 formed in the first region R1 is connected to an electrode section (not shown) provided in the support region 21a via an external wiring 61 formed in the support region 21a. In the present embodiment, the lower electrode film 51, the intermediate electrode film 52, and the upper electrode film 53 in each vibrating region 22 are connected to the electrode section via the external wiring 61 and the like, so that changes in the charge in the first region R1 of each vibrating region 22 are output as a single detection signal.

Additionally, in the present embodiment, the upper electrode film 53 formed in the first region R1 is divided into first to third upper electrode films 531 to 533. Furthermore, the first to third upper electrode films 531 to 533 are connected in series via an internal wiring 71 formed in the support region 21a. It should be noted that, in FIG. 1, the external wiring 61 and the internal wiring 71 are omitted for clarity. Additionally, although not specifically illustrated, the intermediate electrode film 52 and lower electrode film 51 are shaped similarly to the first to third upper electrode films 531 to 533, and are divided into first to third intermediate electrode films and first to third lower electrode films, respectively. Furthermore, the first to third intermediate electrode films and the first to third lower electrode films are connected in series via the internal wiring (not shown in the figures). In this embodiment, by dividing the electrode film 50 formed in the first region R1 in this manner, multiple capacitances are connected in parallel, thereby improving the detection sensitivity. Hereinafter, in the second region R2 of the vibrating region 22, the section along the normal direction where the first upper electrode film 531 is placed is referred to as the first section R11, the section along the normal direction where the second upper electrode film 532 is placed is referred to as the second section R12, and the section along the normal direction where the third upper electrode film 533 is placed is referred to as the third section R13.

The lower electrode film 51, the intermediate electrode film 52, and the upper electrode film 53 formed in the second region R2 are not electrically connected to each electrode section and are in the suspending state. The suspending state may also be referred to as a hanging state or a floating state. Although the lower electrode film 51, the intermediate electrode film 52, and the upper electrode film 53 formed in the second region R2 are not strictly necessary, in this embodiment, they are provided to protect the portions of the lower piezoelectric film 41 and the upper piezoelectric film 42 that are located in the second region R2.

Although not specifically illustrated, the piezoelectric sensor may also include a base film on which the lower piezoelectric film 41 and lower electrode film 51 are placed. In other words, the piezoelectric sensor may have the piezoelectric film 40 and electrode film 50 arranged on the base film. The base film is provided to facilitate crystal growth during the formation of the lower piezoelectric film 41 and other layers, and it is made of materials such as aluminum nitride. Additionally, when the base film is provided, the base film has a thickness of approximately several tens of nanometers, making it extremely thin compared to the piezoelectric film 40. Therefore, in a configuration where the base film is provided, the base film located in the suspending region 21b also contributes to forming each vibrating region 22, resulting in the vibrating region 22 including the base film in its structure.

The vibration unit 20 is formed by depositing and patterning the piezoelectric film 40 and electrode film 50 using methods such as sputtering, as will be described later. Here, it has been reported that the piezoelectric film 40 tends to exhibit reduced piezoelectricity when tensile stress increases. Therefore, the piezoelectric sensor is configured such that compressive stress remains in the vibrating region 22. However, when compressive stress exists in the vibrating region 22, there is a possibility that the sensitivity may decrease if the vibrating region 22 buckles. In the vibrating region 22 of the present embodiment, the free end side is in an open state, making it difficult for buckling to occur due to compressive stress. However, there is a possibility that buckling may occur in the fixed end side portion due to compressive stress. In other words, in the vibrating region 22 of the present embodiment, buckling is more likely to occur in the first region R1 than in the second region R2.

Therefore, in the present embodiment, a through-hole 81 that penetrates between the first surface 22a and the second surface 22b of the vibrating region 22 is formed in the first region R1. In the present embodiment, three through-holes 81 are formed in each vibrating region 22 so as to penetrate the first section R11, the second section R12, and the third section R13, respectively. Additionally, in the present embodiment, the through-holes 81 are cylindrical with a perfectly circular shape at the openings, and are formed along the normal direction. Furthermore, in the present embodiment, the width (i.e., diameter) d of the opposing portions of the opening of the through-holes 81 is set to be equal to or greater than the slit width W. In the present embodiment, the through-holes 81 correspond to stress relief holes.

The above describes the configuration of the piezoelectric sensor in the present embodiment. When sound pressure is applied to each vibrating region 22 of such a piezoelectric sensor, each vibrating region 22 vibrates. In this case, for example, when the free end side of each vibrating region 22 is displaced upward, tensile stress occurs in the lower piezoelectric film 41 while compressive stress occurs in the upper piezoelectric film 42, causing a change in the charges of the lower piezoelectric film 41 and the upper piezoelectric film 42. Therefore, the sound pressure applied to the vibrating region 22 is detected based on the charges of the lower piezoelectric film 41 and the upper piezoelectric film 42.

At this time, the stress generated in the vibrating region 22 (i.e., the piezoelectric film 40) is released at the free end side, so the stress is greater at the fixed end side than at the free end side. In other words, the free end side generates less charge, making it easier for the signal-to-noise ratio (SNR) to decrease. Therefore, in the piezoelectric sensor of the present embodiment, as described above, each vibrating region 22 is divided into a first region R1, where stress tends to be large, and a second region R2, where stress tends to be small. In the piezoelectric sensor, the charges generated in the lower piezoelectric film 41 and the upper piezoelectric film 42 located in the first region R1 are extracted from the lower electrode film 51, the upper electrode film 53, and the intermediate electrode film 52, which are positioned in the first region R1. This configuration helps to suppress the increase in noise influence.

In this embodiment, through-holes 81 are formed in the first region R1, where the charges are extracted and where compressive stress tends to be large. Therefore, the compressive stress in the first region R1 can be released through the through-holes 81, thus preventing buckling in the vibrating region 22. Thus, it is possible to prevent the sensitivity of the piezoelectric sensor from decreasing.

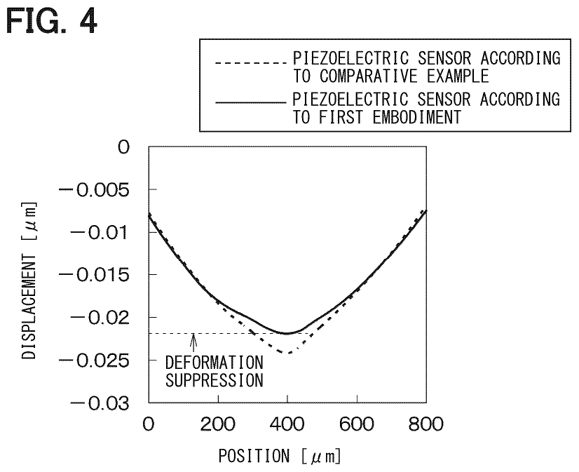

Here, the inventors of the present application have diligently examined the displacement amount of the vibrating region 22 in the piezoelectric sensor of this embodiment and obtained the results shown in FIG. 4. In FIG. 4, a piezoelectric sensor without the through-holes 81 of this embodiment, but with other configurations being the same as this embodiment, is used as a comparative example. The figure shows the displacement amounts of each vibrating region 22 when no sound pressure is applied to the vibrating region 22. Additionally, FIG. 4 shows the displacement amounts along the IV-IV line in FIG. 3, with the boundary between the support member 10 and the vibration unit 20 as the reference (i.e., 0). The displacement of the vibrating region 22 towards the support member 10 side is indicated as negative. Furthermore, FIG. 4 illustrates the case where the length L of first end portion 221 of the vibrating region 22 is 900 μm, the width d of the through-hole 81 is 60 μm, and the position 400 μm from the end is indicated as the central part of the second section R12, as shown in FIG. 1.

As shown in FIG. 4, it is confirmed that in this embodiment, since the through-hole 81 is formed, the displacement amount of the vibrating region 22 can be reduced. In other words, it is confirmed that the vibrating region 22 is less likely to undergo deformation due to buckling.

The through-hole 81 in this embodiment is cylindrical with a perfectly circular opening, but the shape of the opening can be appropriately modified. It may be oval or polygonal. Additionally, the number of through-holes 81 can be modified as appropriate.

Next, the manufacturing method of the piezoelectric sensor will be briefly described.

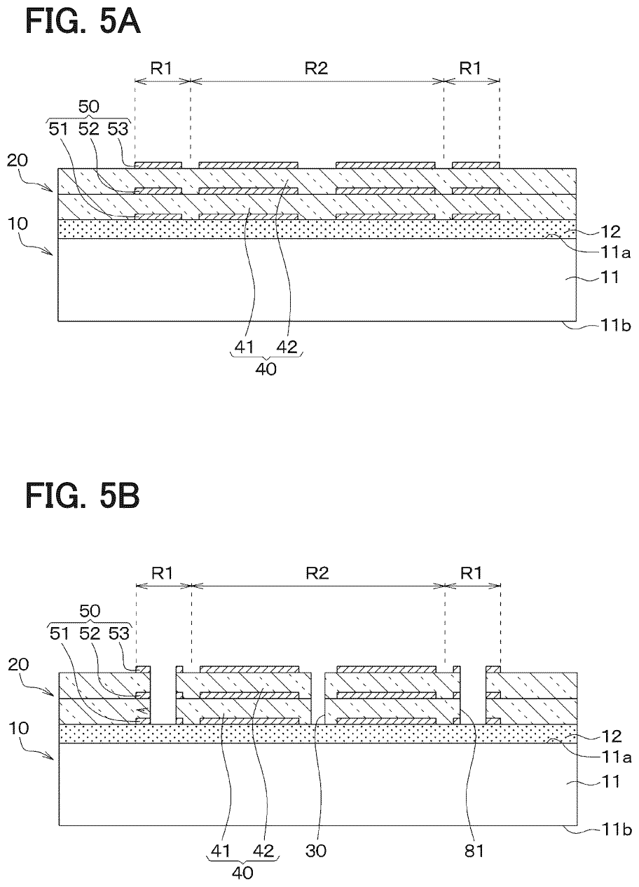

First, as shown in FIG. 5A, the support member 10 without the recess 10a is prepared, and then the piezoelectric film 40 and electrode film 50 are deposited using appropriate methods such as sputtering or etching. At this time, the piezoelectric film 40 is formed such that compressive stress remains in at least the portion that will become the vibrating region 22 by appropriately adjusting the conditions during sputtering. Next, as shown in FIG. 5B, a resist or the like (not shown) is placed on the vibration unit 20, and slits 30 and through-holes 81 are appropriately formed by etching or other methods. Thereafter, although not specifically illustrated, the piezoelectric sensor is manufactured by forming the recess 10a through etching or other methods from the second surface 11b side of the support substrate 11, thereby forming the suspending region 21b (i.e., the vibrating region 22).

According to the embodiment described above, the through-hole 81 is formed in the vibration unit 20. Therefore, the compressive stress in the vibrating region 22 can be released through the through-hole 81, preventing the vibrating region 22 from buckling. Additionally, since it is not necessary to thicken the vibrating region 22, the sensitivity is not reduced by the through-hole 81. Therefore, the reduction in sensitivity can be prevented.

In this embodiment, the vibrating region 22 has a cantilever structure, and the through-hole 81 is formed in the first region R1 on the side of first end portion 221. In other words, the through-hole 81 is formed in a region where buckling is likely to occur due to compressive stress. Therefore, the sensitivity can be further prevented from decreasing.

### Second Embodiment

A second embodiment will be described. In the present embodiment, the shape of the through-hole 81 has been modified from that in the first embodiment. Other aspects are the same as those in the first embodiment, and therefore the explanation will be omitted here.

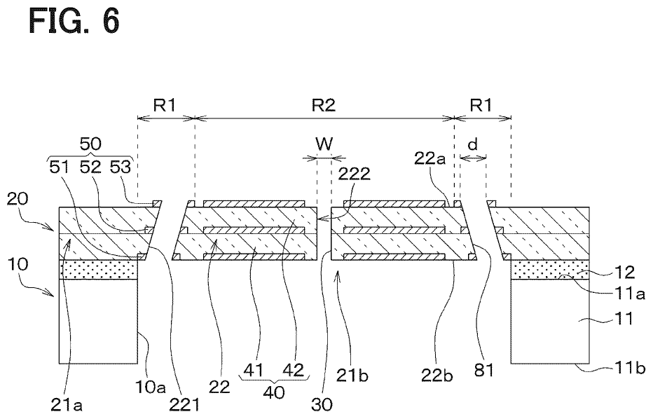

In the piezoelectric sensor of the present embodiment, as shown in FIG. 6, the through-hole 81 is formed to be tilted in the normal direction. Therefore, compared to the case where the through-hole 81 is formed along the normal direction as in the first embodiment, the length of the through-hole 81 becomes longer, and the hole resistance (i.e., pipe resistance) concerning the passage of sound increases. Specifically, the through-hole 81 is formed such that the hole resistance concerning the passage of sound is greater than the slit resistance (i.e., pipe resistance) of the slits 30 that partition each vibrating region 22. Therefore, by forming the through-hole 81, it is possible to suppress the escape of sound from the through-hole 81, thereby preventing a decrease in sensitivity and changes in the detection bandwidth.

The through-hole 81 is, for example, formed such that the hole resistance is approximately one-tenth of the slit resistance. Additionally, in FIG. 6, the through-hole 81 is shown as being formed to extend from the second surface 22b side toward the first surface 22a side toward the second end 222. However, the through-hole 81 may also be formed to extend from the first surface 22a side toward the second surface 22b side toward the second end portion 222.

According to the embodiment described above, since the through-hole 81 is formed in the vibrating region 22, the same effects as those in the first embodiment can be obtained.

In the present embodiment, the through-hole 81 is formed such that the hole resistance is greater than the slit resistance. Therefore, by forming the through-hole 81, it is possible to suppress sound from escaping through the through-hole 81. In other words, by forming the through-hole 81, it is possible to prevent a decrease in sensitivity and changes in the detection bandwidth.

### Third Embodiment

A third embodiment will be described. This embodiment is a modification of the first embodiment, in which the shape of the through-hole 81 has been changed. Other aspects are the same as those in the first embodiment, and therefore, a detailed description will be omitted here.

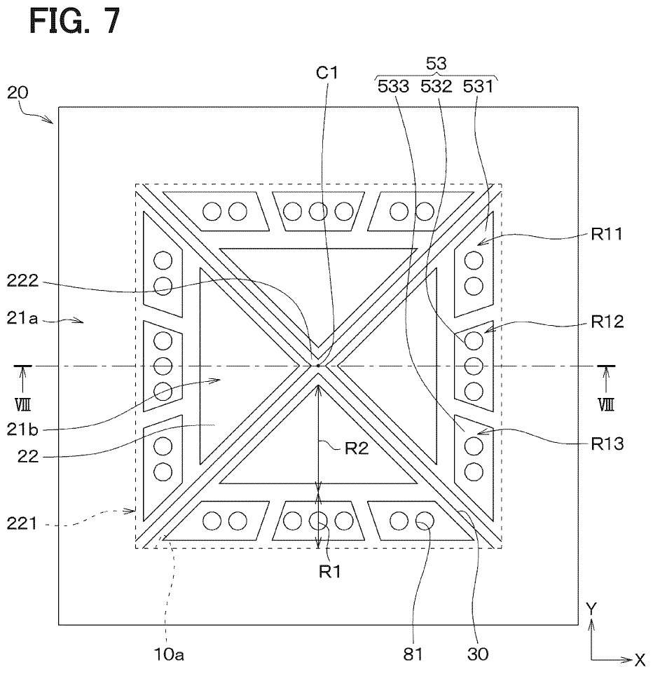

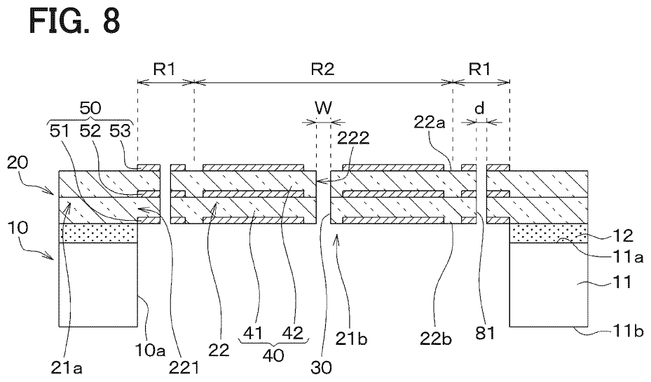

In the piezoelectric sensor of this embodiment, as shown in FIGS. 7 and 8, the through-hole 81 is formed along the normal direction. However, the width d of the through-hole 81 is made narrower than the width W of the slit 30. Therefore, compared to the case where the width d of the through-hole 81 is equal to or greater than the width W of the slit 30, as in the first embodiment, the hole resistance is increased. Specifically, the through-hole 81 in this embodiment is formed such that the hole resistance becomes greater than the slit resistance. Therefore, by forming the through-hole 81, it becomes easier to suppress sound from escaping through the through-hole 81. The through-hole 81 is formed such that, for example, the hole resistance is approximately one-tenth of the slit resistance.

Additionally, in this embodiment, because the width d of the through-hole 81 is reduced, there is a possibility that the function of releasing the compressive stress in the vibrating region 22 may be diminished. Therefore, in this embodiment, the number of through-holes 81 is increased compared to the first embodiment.

According to the embodiment described above, since the through-hole 81 is formed in the vibrating region 22, similar effects to those of the first embodiment can be achieved.

In this embodiment, the through-hole 81 is formed such that the hole resistance is greater than the slit resistance. Therefore, by forming the through-hole 81, it is possible to suppress sound from escaping through the through-hole 81. In other words, by forming the through-hole 81, it is possible to prevent a decrease in sensitivity and changes in the detection bandwidth.

### Fourth Embodiment

A fourth embodiment will be described. In this embodiment, the configuration of the stress relief hole has been modified from that in the first embodiment. Except for the aforementioned change, the other aspects are the same as those in the first embodiment, and therefore, the explanation is omitted here.

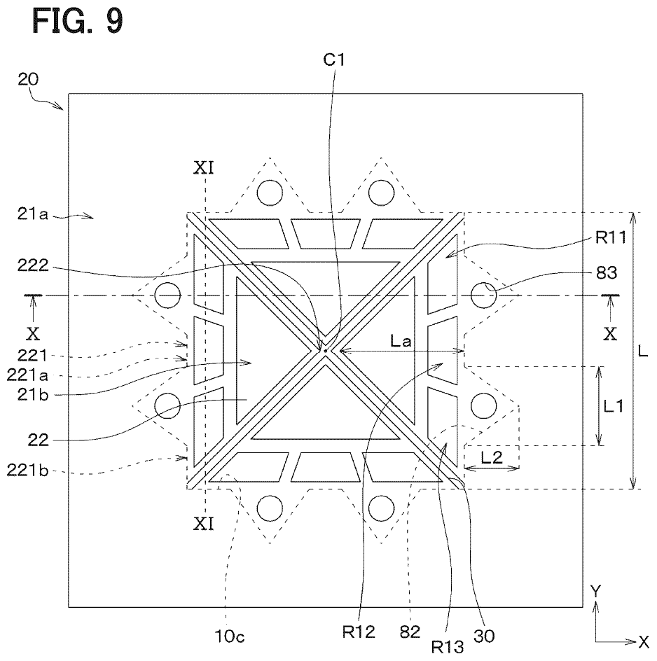

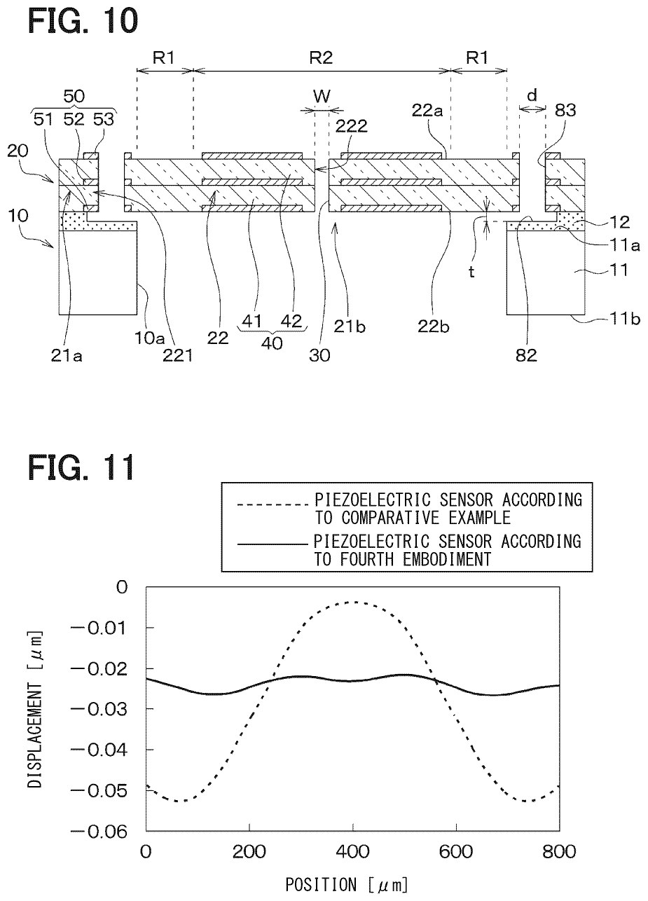

In this embodiment, as shown in FIGS. 9 and 10, the through-hole 81 is not formed in the vibrating region 22, but the through-hole 83 is formed in the support region 21a. Specifically, in this embodiment, a cavity 82, which serves as a hole communicating with the recess 10a, is formed in the portion of the insulating film 12 on the recess 10a side of the support member 10. More specifically, the cavity 82 includes a recessed portion where the surface of the insulating film 12 on the vibration unit 20 side has been removed.

Additionally, the cavity 82 is designed such that the depth t is shallower than the width W of the slit 30, so that the cavity resistance (i.e., piping resistance) to the passage of sound is greater than the slit resistance. For example, the depth t of the cavity 82 is adjusted such that the piping resistance in the stress relief hole, which is formed by communicating with the through-hole 83 described later, is about 1/10 of the slit resistance.

Furthermore, in this embodiment, the cavity 82 is formed such that, on a first end portion 221 side of each vibrating region 22, the inner edge portion 221a of the first end portion 221 is supported by the support member 10 (i.e., the insulating film 12). In other words, the cavity 82 is not formed in a manner that suspends the inner edge portion 221a of the first end portion 221 in each vibrating region 22.

Additionally, in this embodiment, the cavity 82 is formed such that, on the first end portion 221 side of each vibrating region 22, the outer edge portion 221b of the first end portion 221 is supported by the support member 10 (i.e., the insulating film 12). In other words, the cavity 82 is not formed in a manner that suspends the outer edge portion 221b of the first end portion 221 in each vibrating region 22.

Therefore, in this embodiment, the first end portion 221 on the support region 21a side of the vibrating region 22 is configured such that, as viewed from one side to the other side of the first end portion 221, there are a supporting section supported by the support member 10, a suspending section hanged from the support member 10, a supporting section supported by the support member 10, a suspending section hanged from the support member 10, and a supporting section supported by the support member 10.

Here, when the vibrating region 22 is configured by stacking the piezoelectric film 40 and the electrode film 50 as in this embodiment, differences in the internal stress may arise due to variations in the stacked structure. For example, on the first end portion 221 side of the vibrating region 22, the internal stress differs between the parts where the electrode film 50 is present and the parts where the electrode film 50 is not present. That is, on the first end portion 221 side of the vibrating region 22, there are regions with high compressive stress and regions with lower compressive stress compared to the former. The regions with lower compressive stress also include regions where tensile stress is present.

In this embodiment, the parts where the electrode film 50 is not present are configured to have higher compressive stress compared to the parts where the electrode film 50 is present. For example, in this embodiment, the vibrating region 22 is configured such that the compressive stress is higher in the areas between the first section R11 and the second section R12, and between the second section R12 and the third section R13, compared to the compressive stress in the first section R11, the second section R12, and the third section R13. In this embodiment, the cavity 82 is formed to suspend the regions between the first section R11 and the second section R12, as well as the regions between the second section R12 and the third section R13, where the compressive stress is higher on the first end portion 221 side.

In this embodiment, two cavities 82 are formed so that each vibrating region 22 is supported by the support member 10 as described above. Specifically, one of the cavities 82 is formed to suspend the region between the inner edge portion 221a and one outer edge portion 221b at first end portion 221. The other cavity 82 is formed to suspend the region between the inner edge portion 221a and the other outer edge portion 221b. Additionally, the cavity 82 in this embodiment is formed to be approximately triangular in shape in the normal direction.

Furthermore, the through-hole 81 formed in the support region 21a is configured to communicate with the cavity 82. In this embodiment, the width d of the through-hole 81 is formed to be equal to or greater than the width W of the slit 30. Additionally, in this embodiment, a stress relief hole, which includes the through-hole 81 and the cavity 82, is formed. The stress relief hole is configured to penetrate the vibration unit 20. Furthermore, in this embodiment, since the cavity resistance (i.e., piping resistance) is formed to be greater than the slit resistance, the stress relief hole has a total piping resistance that is greater than the slit resistance.

The above describes the configuration of the piezoelectric sensor in this embodiment. Even in such a piezoelectric sensor, compressive stress can be released through the through-hole 83 and the cavity 82, thereby preventing buckling from occurring in the vibrating region 22. Therefore, it is possible to prevent a decrease in the sensitivity of the piezoelectric sensor.

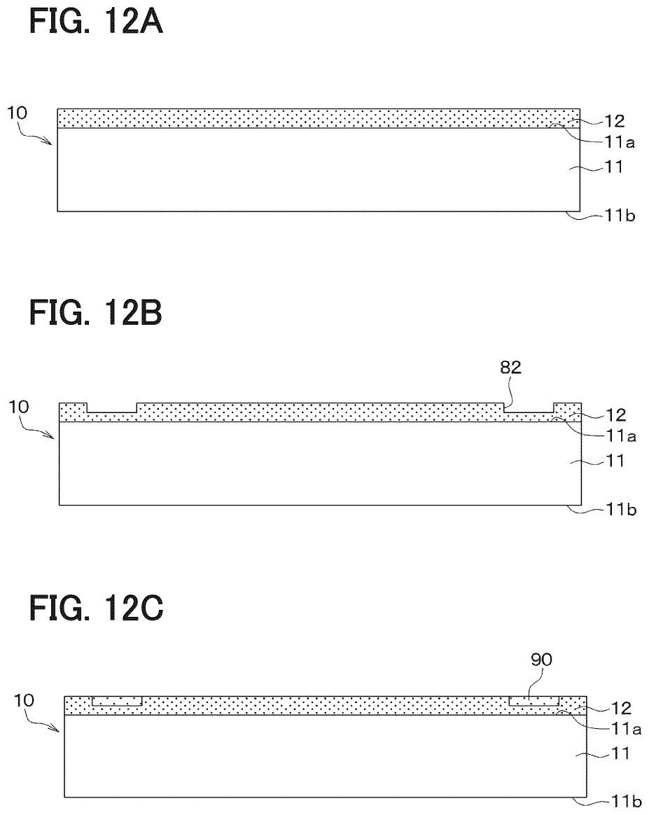

Here, the inventors of the present application have diligently investigated the displacement amount of the vibrating region 22 in the piezoelectric sensor of this embodiment and obtained the results shown in FIG. 11. In FIG. 11, a piezoelectric sensor in which the through-hole 83 and the cavity 82 of this embodiment are not formed, but other configurations are the same as in this embodiment, is used as a comparative example. The figure shows the displacement amount of each vibrating region 22 when no sound pressure is applied to the vibrating region 22. Furthermore, FIG. 11 shows the displacement amount of the section along the XI-XI line in FIG. 9, with the boundary between the support member 10 and the vibration unit 20 as the reference point (i.e., 0). The displacement of the vibrating region 22 toward the support member 10 side is indicated as negative. Additionally, in FIG. 11, the length L of first end portion 221 of the vibrating region 22 is set to 900 μm, and the width d of the through-hole 81 is set to 60 μm. Moreover, FIG. 11 indicates the case where the length L1 along the longitudinal direction of first end portion 221 in one cavity 82 is set to 300 μm, the length L2 in the direction intersecting the longitudinal direction is set to 150 μm, and the position at 400 μm is considered as the central part of the second section R12. Furthermore, FIG. 11 shows the results in the case where a tensile stress of 50 MPa is generated in the part where the electrode film 50 is located, and a compressive stress of 100 MPa is generated in the part where the electrode film 50 is not located.

As shown in FIG. 11, in this embodiment, since the through-hole 83 and the cavity 82 are formed, it is confirmed that the overall displacement amount of the vibrating region 22 can be reduced. In other words, it is confirmed that the vibrating region 22 is less likely to undergo deformation due to buckling.

Next, a method for manufacturing the above piezoelectric sensor will be described.

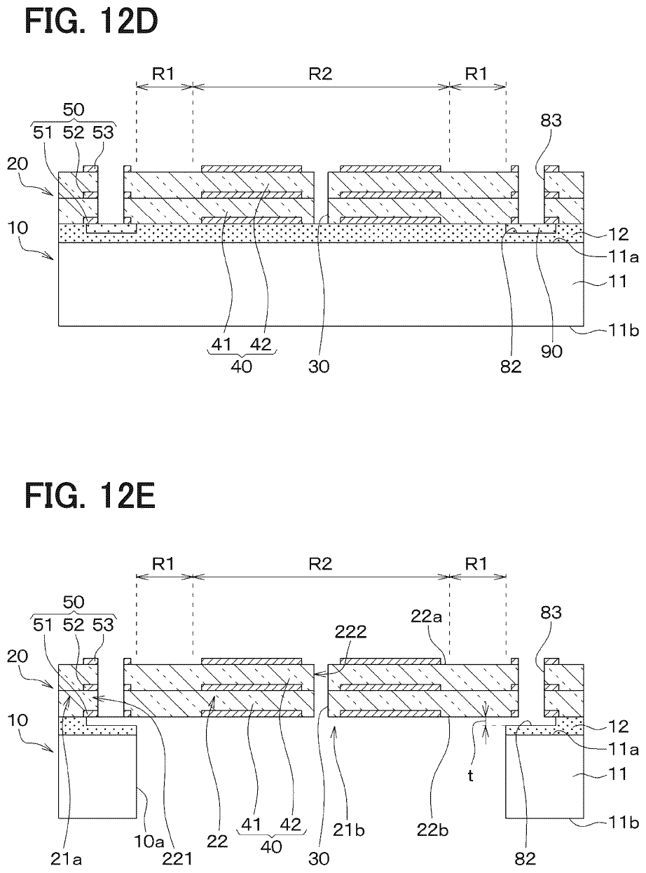

In this embodiment, first, as shown in FIG. 12A, the support member 10 without the recess 10a is prepared. Then, as shown in FIG. 12B, a resist (not shown) is placed on the insulating film 12 and patterned, and by etching using the resist as a mask, the insulating film 12 in the portion constituting the cavity 82 is removed. Subsequently, as shown in FIG. 12C, a filler material 90, which is more easily etched than the insulating film 12 and is made of a material such as a nitride film, is embedded in the portion that will become the cavity 82.

Then, as shown in FIG. 12D, after placing the piezoelectric film 40 and the electrode film 50 by an appropriate method such as sputtering or etching, the slit 30 and through-hole 83 are formed. The through-hole 83 is formed in the portion that will become the support region 21a and is created to reach the filler material 90. Subsequently, as shown in FIG. 12E, the recess 10a is formed by performing etching or the like from the second surface 11b side of the support substrate 11. At this time, in the present embodiment, the filler material 90 is made of a material that is more easily etched than the insulating film 12. Therefore, when forming the recess 10a, side etching removes the filler material 90, thereby creating the cavity 82.

As described above in this embodiment, the through-hole 83 and the cavity 82 are formed as stress relief holes in this embodiment. Therefore, the compressive stress in the vibrating region 22 can be released through the through-hole 83 and the cavity 82, achieving the same effects as in the first embodiment.

In this embodiment, no through-hole 81 is formed in the vibrating region 22.

In this embodiment, the cavity 82 is formed such that the inner edge portion 221a of first end portion 221 of the vibrating region 22 is supported by the support member 10. Therefore, the length of the vibrating region 22 that actually vibrates is the same as in the first embodiment, making the resonance frequency and other characteristics of the vibrating region 22 less likely to change.

In this embodiment, the cavity 82 is formed such that the outer edge portion 221b of the first end portion 221 of the vibrating region 22 is supported by the support member 10. Therefore, changes in the resonance frequency and other characteristics of the vibrating region 22 can be further suppressed.

In this embodiment, the stress relief hole is formed such that the piping resistance is greater than the slit resistance. Therefore, by forming the cavity 82 and the through-hole 83 as the stress relief hole, it is possible to prevent sound from escaping through the stress relief hole. In other words, forming the stress relief hole can prevent a decrease in sensitivity and changes in the detection bandwidth.

In this embodiment, the cavity 82 is formed to suspend the region with high compressive stress at the first end portion 221 of the vibrating region 22. Therefore, it is possible to further suppress the occurrence of buckling in the vibrating region 22.

### Other Embodiments

The present disclosure has been described in accordance with the embodiments, but it is understood that the present disclosure is not limited to these embodiments or structures. The present disclosure also encompasses various modifications and alterations within the scope of equivalents. In addition, various combinations and configurations, including those that incorporate only one element, more elements, or fewer elements, also fall within the scope and spirit of the present disclosure.

For example, in the above embodiments, the piezoelectric sensor was described as an example of the acoustic sensor. However, as long as the configuration includes the vibrating region 22, the acoustic sensor may be, for example, a capacitive sensor or the like.

In the above embodiments, a configuration in which the vibrating region 22 is cantilevered was described as an example. However, the vibrating region 22 may also be configured to be supported at both ends.

Furthermore, in the above embodiments, the recess 10a may be formed such that a part of the support member 10 remains, and the vibrating region may be configured to include a part of the support member 10. For example, the recess 10a may be formed such that the insulating film 12 remains while the support substrate 11 is removed, and the vibrating region 22 may be configured to include the insulating film 12.

Furthermore, in the above embodiments, the electrode film 50 formed in the second region R2 may be electrically connected to the electrode film 50 formed in the first region R1.

Additionally, in the first to third embodiments described above, the configuration in which the through-hole 81 serves as a stress relief hole penetrating the vibration unit 20 has been explained. However, the through-hole does not necessarily need to be formed to pass through the vibration unit 20. Similarly, in the fourth embodiment, the configuration in which the cavity 82 and the through-hole 83, serving as stress relief holes, communicate and penetrate the vibration unit 20 has been described. However, the cavity 82 and the through-hole 83 may be formed separately, or only one of them may be formed.

Additionally, in the first to third embodiments, the through-hole 81 may be formed in the second region R2.

Furthermore, in the fourth embodiment, the cavity 82 may be formed such that the cavity resistance is smaller than the slit resistance. Additionally, the location and shape of the cavity 82 can be modified as appropriate. For example, the cavity 82 may be formed in such a way as to suspend the inner edge portion 221a of the vibrating region 22, or it may be formed to suspend the outer edge portion 221b of the vibrating region 22.

Moreover, the various embodiments described above can be combined. For example, the second and third embodiments can be combined, such that the through-hole 81 tilts to the normal direction while making the width d narrower than the width W of the slit. Moreover, the second embodiment can be combined with the fourth embodiment, such that the through-hole 83 tilts to the normal direction. Additionally, the third embodiment can be combined with the fourth embodiment, such that the width of the through-hole 83 is narrower than the width W of the slit 30. That is, the through-hole 83 may be formed such that the hole resistance is greater than the slit resistance. Furthermore, the first embodiment can be combined with the fourth embodiment, such that a through-hole 81 is formed in the vibrating region 22 while forming the cavity 82 in the support member 10 and the through-hole 83 in the support region 21a. Additionally, it is possible to further combine combinations of the aforementioned embodiments.

What is claimed is:

1. An acoustic sensor comprising:
a support member; and
a vibration unit being located on the support member, the vibration unit including a support region and a vibrating region, the support region being supported by the support member, the vibrating region configured to generate vibration, the vibration unit configured to output a detection signal according to deformation of the vibrating region, wherein
the support member includes a section having a recess, the section being located to face the vibrating region,
the vibrating region includes a section configured to receive a compressive stress, and
the vibration unit has a stress relief hole.

2. The acoustic sensor according to claim 1, wherein
the vibration unit includes a piezoelectric film and an electrode film,
the piezoelectric film includes:
a lower piezoelectric film; and
an upper piezoelectric film being located on the lower piezoelectric film,
the electrode film is configured to extract a charge generated in deformation of the piezoelectric film, and
the electrode film includes:
a lower electrode film that is connected to the lower piezoelectric film;
an intermediate electrode film that is connected to the lower piezoelectric film and the upper piezoelectric film; and
an upper electrode film that is connected to the upper piezoelectric film.

3. The acoustic sensor according to claim 2, wherein
the vibrating region is connected to the support region, and is divided into vibrating segments by a slit that splits a suspended portion of the vibrating region,
the suspended portion hangs from the support member,
the vibrating region includes a first end portion and a second end portion,
the first end portion being adjacent to the support region is a fixed end that is fixed to the support member, and
the second end portion is a cantilever structure being a free end.

4. The acoustic sensor according to claim 3, wherein
the vibrating region includes:
a first region at the first end portion; and
a second region at the second end portion,
the electrode film is located on at least the first region, and
the stress relief hole is a through-hole that penetrates the vibrating region that is located at the first region.

5. The acoustic sensor according to claim 4, wherein
the through-hole has a resistance to a sound that has passed through the through-hole,
the slit has a resistance to a sound that has passed through the slit, and
the resistance of the through-hole has a larger value than the resistance of the slit.

6. The acoustic sensor according to claim 5, wherein
the through-hole is oblique to a stacking direction of the support member and the vibration unit.

7. The acoustic sensor according to claim 5, wherein
a width of an opening of the through-hole is smaller than a width of the slit between the vibrating segments that are adjacent to each other.

8. The acoustic sensor according to claim 3, wherein
the support member has a cavity adjacent to the vibration unit,
the cavity communicates with the recess,
the support region has a through-hole that penetrates the support region to communicate with the cavity, and
the stress relief hole includes the cavity and the through-hole.

9. The acoustic sensor according to claim 8, wherein
the cavity has a resistance to a sound that has passed through the through-hole,
the slit has a resistance to a sound that has passed through the slit, and
the resistance of the cavity has a larger value than the resistance of the slit.

10. The acoustic sensor according to claim 8, wherein
the cavity has a depth that is smaller than a width of the slit between the vibrating segments that are adjacent to each other.

11. The acoustic sensor according to claim 8, wherein
the vibrating region has an inner edge at the first end portion, and
the cavity is positioned such that the inner edge is supported by the support member.

12. The acoustic sensor according to claim 8, wherein
the vibrating region has an outer edge at the first end portion, and
the cavity is positioned such that the outer edge is supported by the support member.

13. The acoustic sensor according to claim 8, wherein
the vibrating region has a first region and a second region that are located on the first end portion,
the first region is configured to receive a higher compressive stress than the second region, and
the cavity is positioned such that the first region hangs from the support member.
